(19) United States
(12) Patent Application Publication
(10) Pub. No.: US 2020/0408406 A1
(43) Pub. Date: Dec. 31, 2020

(54) COMBUSTOR DILUTION HOLE ACTIVE HEAT TRANSFER CONTROL APPARATUS AND SYSTEM

(71) Applicant: RAYTHEON TECHNOLOGIES CORPORATION, Hartford, CT (US)

(72) Inventor: Steven W Burd, Cheshire, CT (US)

(73) Assignee: RAYTHEON TECHNOLOGIES CORPORATION, Hartford, CT (US)

(21) Appl. No.: 17/018,580

(22) Filed: Sep. 11, 2020

Related U.S. Application Data
(62) Division of application No. 14/862,332, filed on Sep. 23, 2015.
(60) Provisional application No. 62/093,162, filed on Dec. 17, 2014.

(51) Int. Cl. F23R 3/06; F02C 6/08; F02C 7/18; F23R 3/00

(52) U.S. Cl. CPC F23R 3/06; F02C 6/08; Y02T 50/60; F23R 3/002; F02C 7/18

(57) ABSTRACT

Systems and methods are described herein whereby an air jet is configured to manipulate local aerodynamics and/or boundary layer flows associated with a dilution hole. A gas turbine component including a combustor panel, a dilution hole located within the combustor panel and an air jet located within the combustor panel positioned in close proximity to the dilution hole is described. The dilution hole is configured to produce a flow of cooling fluid. An air flow from the air jet is configured to deflect secondary flows produced within a combustor. The air jet is located close enough to a leading edge of the dilution hole such that the air flow from the air jet manipulates a pressure gradient of the dilution hole. The air jet extends through a wall defining the dilution hole to provide an air jet inlet fed by an air flow passing through the dilution hole.

### CROSS-REFERENCE TO RELATED APPLICATIONS

This application is a divisional of, and claims priority to, and the benefit of U.S. patent application Ser. No. 14/862,332, filed on Sep. 23, 2015, and entitled “COMBUSTOR DILUTION HOLE ACTIVE HEAT TRANSFER CONTROL APPARATUS AND SYSTEM,” which is a nonprovisional of, and claims priority to, and the benefit of U.S. Provisional Application No. 62/093,162, entitled “COMBUSTOR DILUTION HOLE ACTIVE HEAT TRANSFER CONTROL APPARATUS AND SYSTEM,” filed on Dec. 17, 2014, which are incorporated by reference herein in their entirety.

### FIELD

The present disclosure relates generally to a gas turbine engine and, more specifically, to turbine blades and/or vanes exposed to high temperature.

### BACKGROUND

A gas turbine engine may include a turbine section with multiple rows or stages of stator vanes and rotor blades that interact or react with a high temperature gas flow to create mechanical power. In a gas turbine engine, the turbine rotor blades drive the compressor and an electric generator to generate electrical power.

The efficiency of the gas turbine engine can be increased by passing a higher temperature gas flow through the turbine. However, the turbine inlet temperature is limited to the vane and blade (airfoils) material properties and the cooling capabilities of these airfoils. The first stage airfoils are exposed to the highest temperature gas flow since these airfoils are located immediately downstream from the combustor. The temperature of the gas flow passing through the turbine progressively decreases as the rotor blade stages extract energy from the gas flow. The leading edge of the vane and blade airfoils is exposed to high temperature gas flow.

Air usually enters the combustor with enough momentum to act like an air jet in cross-flow. An air jet from an air jet opening 10 in cross-flow (see prior art FIG. 1) is a complex interaction and results in undesired combustor liner distress (i.e. oxidation) local to dilution and trim holes. This occurs for several reasons. The presence of this air jet disturbs the approaching flow along the walls of and pressure gradients within the combustor and promotes the formation of secondary flow or vortical structures 05. These secondary flows and vortical structures 05 disrupt (and reduce) the cooling in the vicinity of the combustor liners by mixing with the cooling air and driving hot gases from the combustion process to liner surfaces, such as the top coat 15 of the combustor panel. Since this mixture is undergoing combustion, it can greatly exceed the melting point of the combustor liner materials. In addition, the air jets provide a blockage for the approaching flow. This means that the flow accelerates around the dilution holes on the combustor liner surfaces, such as the top coat 15, increasing the heat transfer and the strength of the local secondary flows. Moreover, the jet in cross-flow may create a wake that promotes downwash of hot gases around the holes. The interaction with the approaching flow may not be uniform given swirl and non-homogeneous fuel-air distributions produced by the forward fuel nozzles, air swirlers, the flow of cooling air and the flow of air introduction. This could create a biased distress pattern on the combustor liner surfaces, such as the top coat 15.

### SUMMARY

In various embodiments, adverse effects described above are mitigated at least in part by manipulating the local aerodynamics and/or boundary layer flows. According to various embodiments, a gas turbine component including a combustor panel, a dilution hole located within the combustor panel and an air jet located within the combustor panel positioned in close proximity to the dilution hole. The dilution hole is configured to produce a flow of cooling fluid. An air flow from the air jet is configured to deflect secondary flows produced within a combustor. The air jet is located close enough to a leading edge of the dilution hole such that the air flow from the air jet manipulates a pressure gradient of the dilution hole. The air jet is located on the upstream side of the dilution hole. The air flow from the air jet has less momentum than the flow of cooling fluid exiting the dilution hole. A plurality of air flows from a plurality of air jets may be positioned in close proximity to the dilution hole. The plurality of air flows from a plurality of air jets may combine to manipulate a pressure gradient of the dilution hole. The air jet is located at least one of to a side between the leading edge and aft of the dilution hole and aft of the dilution hole. The air flow from the air jet is configured to reduce at least one of downwash flow or a recirculating flow and associated vortical structures from bringing the hot temperatures within a combustor down to a liner surface of the combustor.

According to various embodiments, a flow area of the air jet is an order of magnitude larger than a conventional trim hole. For instance, a flow area of the air jet is about 10 times larger than a conventional trim hole. A shape of an opening of the air jet may mirrors a portion of the shape of an opening of the dilution hole. The opening of the air jet may mirror the curvature of the opening of the dilution hole. The air jet extends through the panel to be fed by a different source as compared to the source of the flow of cooling fluid to the dilution hole. The air jet extends through a feature of the dilution hole to be fed by the source of the flow of cooling fluid to the dilution hole.

According to various embodiments, a cooling assembly may include an air jet disposed in a panel. The air jet located within the combustor panel may be positioned in close proximity to a cooling air producing structure. An air flow from the air jet is configured reduce at least one of downwash flow or a recirculating flow and associated vortical structures from bringing the hot temperatures to a liner surface surrounding the cooling air producing structure. The air jet may be located close enough to a leading edge of the dilution hole such that the air flow from the air jet manipulates and/or influences a pressure gradient of cooling air producing structure. A shape of an opening of the air jet mirrors a portion of the shape of an opening of the dilution hole. The opening of the air jet may mirror the curvature of the opening of the dilution hole. The air jet may extend through the panel to be fed by a different source as compared to the source of the flow of cooling fluid to the dilution hole. The air jet extends through a feature of the dilution hole to be fed by the source of the flow of cooling fluid to the dilution hole.

According to various embodiments, a method of deflect secondary flows produced within a combustor may include positioning an air jet in close proximity to a dilution hole in a panel. The method may include expelling an air flow from the air jet to manipulate a pressure gradient of the dilution hole.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates an isometric view of a prior art air jet from an air jet opening in cross-flow creating a secondary flow and vortical structure;

FIG. 2 illustrates a cross-sectional view of an exemplary gas turbine engine, in accordance with various embodiments;

FIG. 3 illustrates an isometric view of a portion of the combustor, in accordance with various embodiments;

FIG. 4 illustrates cross-sectional view of a dilution hole and air jet in accordance with various embodiments;

FIG. 5A illustrates cross-sectional view of a dilution hole and air jet fed by a common source in accordance with various embodiments;

FIG. 5B illustrates cross-sectional view of an air jet fed by a plurality of sources in accordance with various embodiments; and

FIGS. 6A-6D illustrates top views of various dilution hole and air jet breakout layouts in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with this invention and the teachings herein. Thus, the detailed description herein is presented for purposes of illustration only and not of limitation. The scope of the invention is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion.

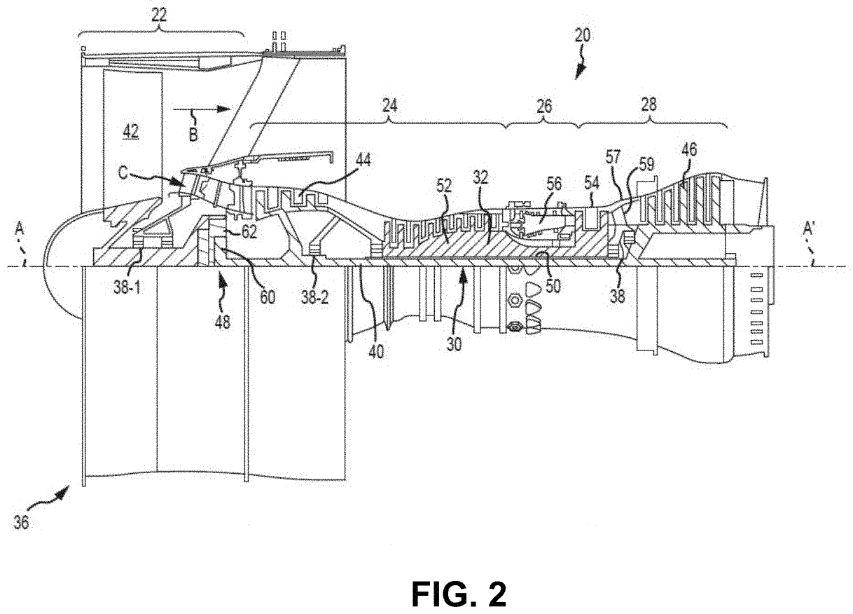

In various embodiments and with reference to FIG. 2, a gas turbine engine 20 is provided. Gas turbine engine 20 may be a two-spool turbofan that generally incorporates a fan section 22, a compressor section 24, a combustor section 26 and a turbine section 28. Alternative engines may include, for example, an augmenter section among other systems or features. In operation, fan section 22 can drive air along a bypass flow-path B while compressor section 24 can drive air along a core flow-path C for compression and communication into combustor section 26 then expansion through turbine section 28. Although depicted as a turbofan gas turbine engine 20 herein, it should be understood that the concepts described herein are not limited to use with turbofans as the teachings may be applied to other types of turbine engines including three-spool architectures.

Gas turbine engine 20 may generally comprise a low speed spool 30 and a high speed spool 32 mounted for rotation about an engine central longitudinal axis A-A′ relative to an engine static structure 36 via one or more bearing systems 38 (shown as bearing system 38-1 and bearing system 38-2 in FIG. 2). It should be understood that various bearing systems 38 at various locations may alternatively or additionally be provided, including for example, bearing system 38, bearing system 38-1, and bearing system 38-2.

Low speed spool 30 may generally comprise an inner shaft 40 that interconnects a fan 42, a low pressure (or first) compressor section 44 (also referred to a low pressure compressor) and a low pressure (or first) turbine section 46. Inner shaft 40 may be connected to fan 42 through a geared architecture 48 that can drive fan 42 at a lower speed than low speed spool 30. Geared architecture 48 may comprise a gear assembly 60 enclosed within a gear housing 62. Gear assembly 60 couples inner shaft 40 to a rotating fan structure. High speed spool 32 may comprise an outer shaft 50 that interconnects a high pressure compressor (“HPC”) 52 (e.g., a second compressor section) and high pressure (or second) turbine section 54. A combustor 56 may be located between HPC 52 and high pressure turbine 54. A mid-turbine frame 57 of engine static structure 36 may be located generally between high pressure turbine 54 and low pressure turbine 46. Mid-turbine frame 57 may support one or more bearing systems 38 in turbine section 28. Inner shaft 40 and outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The core airflow may be compressed by low pressure compressor 44 then HPC 52, mixed and burned with fuel in combustor 56, then expanded over high pressure turbine 54 and low pressure turbine 46. Mid-turbine frame 57 includes airfoils 59 which are in the core airflow path C. Low pressure turbine 46, and high pressure turbine 54 rotationally drive the respective low speed spool 30 and high speed spool 32 in response to the expansion.

Gas turbine engine 20 may be, for example, a high-bypass geared aircraft engine. In various embodiments, the bypass ratio of gas turbine engine 20 may be greater than about six (6). In various embodiments, the bypass ratio of gas turbine engine 20 may be greater than ten (10). In various embodiments, geared architecture 48 may be an epicyclic gear train, such as a star gear system (sun gear in meshing engagement with a plurality of star gears supported by a carrier and in meshing engagement with a ring gear) or other gear system. Geared architecture 48 may have a gear reduction ratio of greater than about 2.3 and low pressure turbine 46 may have a pressure ratio that is greater than about 5. In various embodiments, the bypass ratio of gas turbine engine 20 is greater than about ten (10:1). In various embodiments, the diameter of fan 42 may be significantly larger than that of the low pressure compressor 44, and the low pressure turbine 46 may have a pressure ratio that is greater than about (5:1). Low pressure turbine 46 pressure ratio may be measured prior to inlet of low pressure turbine 46 as related to the pressure at the outlet of low pressure turbine 46 prior to an exhaust nozzle. It should be understood, however, that the above parameters are exemplary of various embodiments of a suitable geared architecture engine and that the present disclosure contemplates other gas turbine engines including direct drive turbofans.

In various embodiments, the next generation of turbofan engines may be designed for higher efficiency which is associated with higher pressure ratios and higher temperatures in the HPC 52. These higher operating temperatures and pressure ratios may create operating environments that may cause thermal loads that are higher than the thermal loads encountered in conventional turbofan engines, which may shorten the operational life of current components.

In various embodiments, HPC 52 may comprise alternating rows of rotating rotors and stationary stators. Stators may have a cantilevered configuration or a shrouded configuration. More specifically, a stator may comprise a stator vane, a casing support and a hub support. In this regard, a stator vane may be supported along an outer diameter by a casing support and along an inner diameter by a hub support. In contrast, a cantilevered stator may comprise a stator vane that is only retained and/or supported at the casing (e.g., along an outer diameter).

In various embodiments, rotors may be configured to compress and spin a fluid flow. Stators may be configured to receive and straighten the fluid flow. In operation, the fluid flow discharged from the trailing edge of stators may be straightened (e.g., the flow may be directed in a substantially parallel path to the centerline of the engine and/or HPC) to increase and/or improve the efficiency of the engine and, more specifically, to achieve maximum and/or near maximum compression and efficiency when the straightened air is compressed and spun by the rotors.

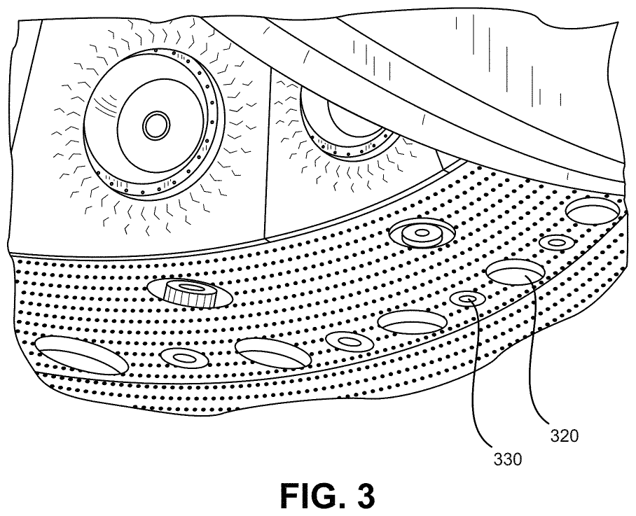

According to various embodiments and with reference to FIG. 3, the systems and apparatus disclosed herein are configured to reduce the local temperature around the dilution holes. This may increase the lifespan of the associated parts. The use of air jets configured to control and/or manipulate the flow field in the vicinity of these air feed, dilution holes 320 or trim holes 330. As used herein dilution holes 320 or trim holes 330 are, in general, apertures in which a flow of air is introduced that becomes part of the combustion process.

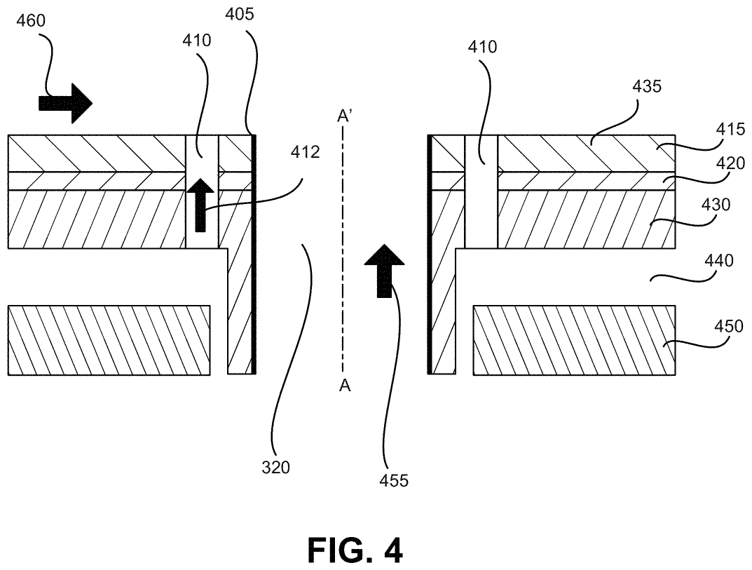

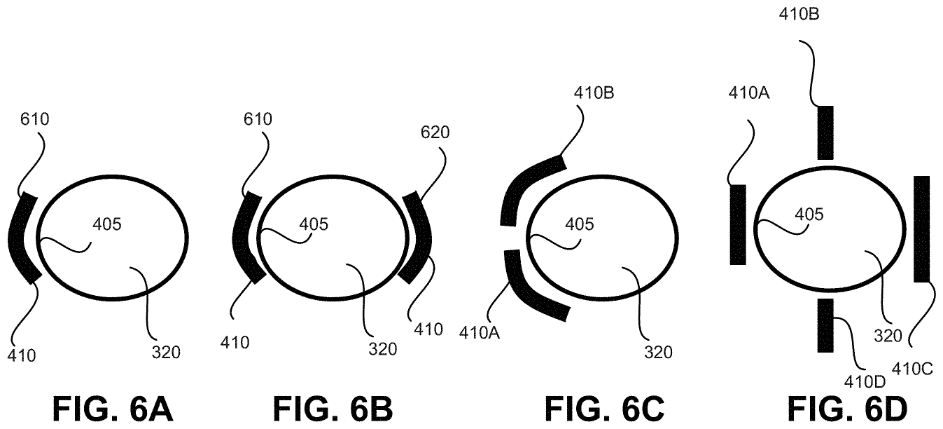

In vanes/nozzle guide vanes in turbines, it has been shown that high-momentum air flows upstream (towards a dilution hole) on the leading surface can change the secondary flow strength, trajectory and other characteristics about the endwalls. In other words, air jets 410 (with brief reference to FIG. 4) can be used to manage, control and deflect the secondary flows that are produced within the combustor. Discrete, elongated air jets 410 that supply high-momentum flow on a portion, such as the flow path side, on the top coat 415 layer of a combustor panel 435 around the exit of dilution hole 320 on a combustor panel. With reference to FIG. 4, the air jets 410 are configured to affect the complex flows produced by air flow 460 in cross-flow, specifically those causing panel distress. Air flow 460 may be a cooling boundary layer/fuel air mixture flow of air/fluid. Air jets 410 may be arranged and/or oriented in a range of patterns to impact the flows at the upstream side 405 of the dilution hole 320, the sides of the dilution hole 320 or the aft region (downstream from) the dilution hole 320 (with brief reference to FIGS. 6A through 6D).

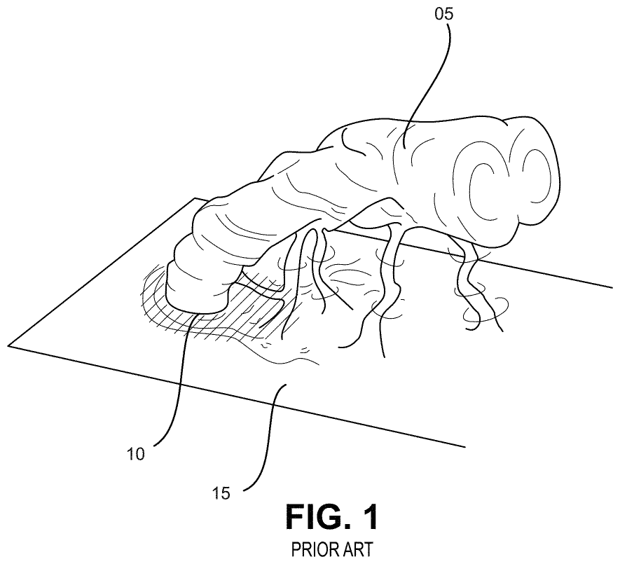

Very high heat transfer rates exist in the vicinity of the dilution holes 320, which at times, may lead to distress. Historically, cooling holes in those areas locally cool the portion of the panel in its immediate vicinity. Air jets 410 are configured to introduce a large enough flow with momentum to manipulate the air flow 460 that is approaching the dilution hole 320, such as from the upstream side 405 of the dilution hole 320. This may reduce undesired vortical structures, such as vortical structures 05 depicted in FIG. 1 from occurring. In this way, air jets 410 are configured to modify the flow of air flow 460 to keep this downwash flow and/or a recirculating flow and associated vortical structures from bringing the hot temperatures within the combustor down to the liner surfaces of the combustor, such as the top coat 415 of the combustor panel.

According to various embodiments, rather than air jets 410 being solely configured as a cooling hole such as trim hole 330, air jets 410 tend to have fairly large aspect ratios. Also, air jets 410 tend to be distributed around the dilution hole in a manner configured to manipulate the boundary layer flow of air flow 460 that is interacting with the dilution hole 320 breakout at the top coat 415 of the combustor panel. According to various embodiments, air jets 410 have flow areas that are an order of magnitude larger than conventional and/or adjacent cooling holes, e.g., trim holes 330 (e.g., 10 times larger, extending greater than 0.100″ in length). Stated another way, while cooling holes may be sized on the order of 0.02 inches to 0.05 inches, air jets 410 are greater than about a ⅛ of an inch. Notably, dilution holes 320 tend to be ¼ of an inch to an inch. The flow area of the air jet 410 may be substantially equal to or less than the flow area of the dilution hole 320.

Air jets 410 are, in general, located in close proximity to a dilution hole 320. Specifically, air jets 410 are located close enough to the leading edge 405 of the dilution hole 320 to manipulate a pressure gradient of the dilution hole 320. At times, the shape of the opening and/or breakout of the air jet 410 mirrors a portion of the shape of the opening of the dilution hole 320. Stated another way, the opening of the air jet 410 mirrors the curvature of the opening of the dilution hole 320.

According to various embodiments, the air jets 410 may extend through the panel, thus, be fed by the air flow 460 across the combustor panel (as shown in FIG. 4). Notably, as depicted in FIG. 4, the air jet 410 passes through the top coat 415, the bond coat 420, and the base metal 430, extending to the liner panel-shell gap 440. As described by its name, the liner panel-shell gap 440 may be between the liner shell 450 and the panel 435, wherein the panel is comprised of the top coat 415, the bond coat 420, and the base metal 430. In this way, the flow of air 412 exiting the air jet 410 may have less momentum than the flow of air 455 exiting the dilution hole 320. In this way, the flow of air 455 exiting the dilution hole 320 may affect the air flow 460 across the combustor panel without adversely impacting the combustion process.

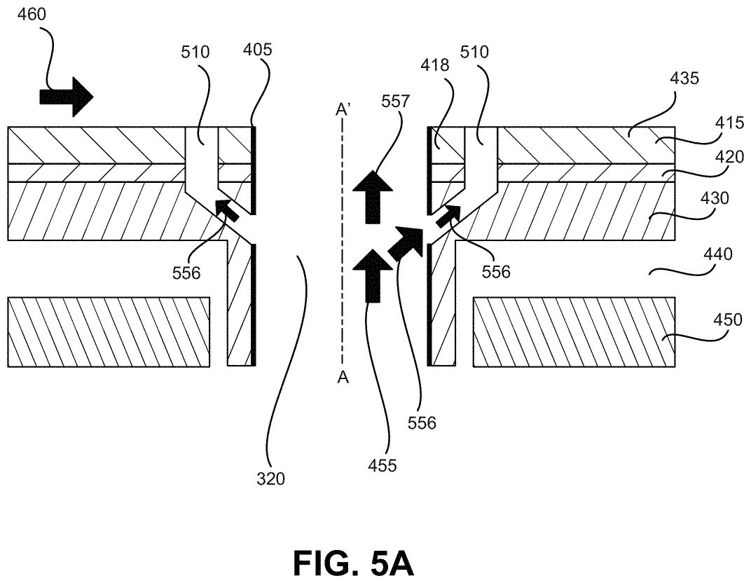

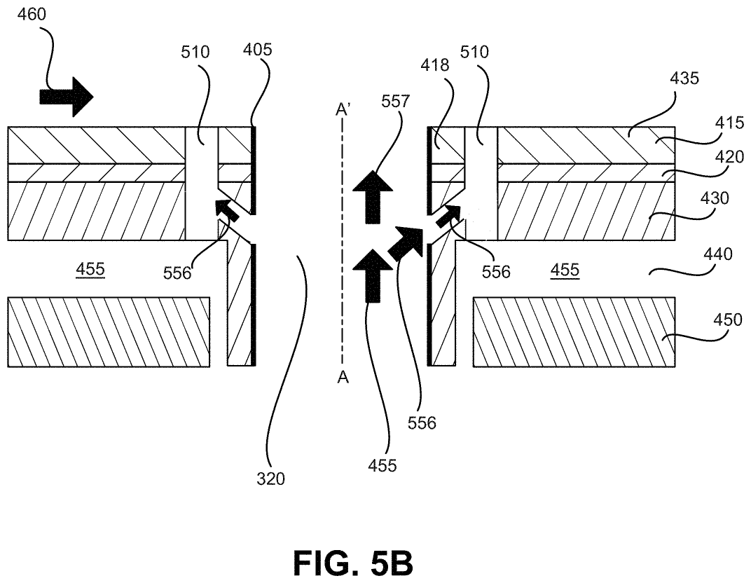

According to various embodiments with reference to FIGS. 5A and 5B, the air jets 510 may extend through a grommet 418 or other feature of the dilution hole 320 to take advantage of the total liner pressure drop (as depicted in FIG. 5A). In this way, the dilution hole 320 air flow and pressure may be the source of the cooling fluid for the air jet 510. In a complementary embodiment, as depicted in FIG. 5B, a branch of the air jet 510 extends into the wall of the dilution hole in addition to extending into the supply plenum 455, to take advantage of the total linear pressure drop. In this way, the flow of air to air jet 510 may be sourced from a diffuser plenum feed (e.g., where air flow 455 is sourced). Local added thickness or webs may be added to the structural features of the dilution hole 320 to accommodate this design. With continued reference to FIGS. 5A and 5B, the air flow 556 to air jet 510 is depicted as being fed from the panel. Based on the geometry of air jet 510 the velocity of air flow 556 is less than the velocity of air flow 557 exiting the dilution hole 320. Stated another way, air flow 455 may be partially diverted into air flow 557 and air flow 556.

According to various embodiments, air jets 510 may be fed from the liner panel-shell gap 440 between the combustor panel 435 and the liner shell 450. According to various embodiments, each air jet 410 and 510 geometry may be specifically tailored to complement the heat pattern associated with a specific associated dilution hole 320. In this way, each panel may comprise a wide arrangement of air jet 410 and air jet 510 geometries. For instance, FIG. 6A depicts a first air jet breakout geometry 610 of an air jet 410 disposed forward of the upstream side 405 of the dilution hole. The first air jet breakout geometry 610 mirrors a portion of the curved wall of dilution hole 320 in accordance with various embodiments. FIG. 6B depicts a first air jet breakout geometry 610 of an air jet 410 disposed forward of the upstream side 405 of the dilution hole 320 and a second first air jet breakout geometry 620 of the air jet 410 aft of the dilution hole 320.

FIG. 6C depicts a pair of air jets 410A and 410B oriented forward of the upstream side 405 of the dilution hole 320 in accordance with various embodiments. FIG. 6D depicts various air jets 410A, 410B, 410C, and 410D oriented in various locations around the breakout of the dilution hole 320 in accordance with various embodiments.

According to various embodiments, air jets 410 and 510 are configured to improve durability and life of the combustor panels and associated apparatus. Air jets 410, 510 manipulate the air flows local to where heat transfer promotes part distress with limited effect on the bulk combustion. The systems and methods described herein may be applicable to other portions of combustor panels subject to distress due to high heat transfer including igniter holes, rails, and studs/attachments.

The designs described herein apply to both a double wall panel construction as well as a single wall construction. The designs described herein apply to dilution holes having an extended and open dilution hole lip orientation. In this way, air jets 410 and 510 may be adapted to facilitate a wide range of dilution hole geometries and/or grommets with a wide range of shapes and configurations. For instance, air jets 410 and 510 may be adapted to facilitate a dilution hole breakout with a rounded edge and/or a dilution hole breakout that is at least partially extended into the flow path 460.

Benefits, other advantages and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A gas turbine component comprising:
a combustor wall;
a dilution hole located within the combustor wall, wherein the dilution hole is configured to conduct a flow of cooling fluid; and
an air jet located within the combustor wall positioned in close proximity to the dilution hole,
wherein an air flow from the air jet is configured to deflect secondary flows produced within a combustor;
the air jet is located in a proximity sufficient to a leading edge of the dilution hole such that the air flow from the air jet influences a pressure gradient in the vicinity of an exit of the dilution hole;
the air jet is located on an upstream side of the dilution hole; and
the air jet extends through a wall defining the dilution hole to provide an air jet inlet fed by an air flow passing through the dilution hole.

2. The gas turbine component of claim 1, wherein a shape of an opening of the air jet mirrors a curvature of an opening of the dilution hole.

3. The gas turbine component of claim 1, wherein the air flow from the air jet is configured to have less momentum than the flow of cooling fluid exiting the dilution hole.

4. The gas turbine component of claim 1, wherein the air jet is located at the leading edge of the dilution hole.

5. The gas turbine component of claim 1, wherein the air flow from the air jet is configured to reduce at least one of downwash flow or a recirculating flow and associated vortical structures from bringing hot temperatures within the combustor down to a liner surface of the combustor.

6. The gas turbine component of claim 1, wherein a flow area of the air jet is substantially equal to or less than the flow area of the dilution hole.

7. The gas turbine component of claim 1, wherein a shape of an opening of the air jet mirrors a portion of the shape of an opening of the dilution hole.

8. The gas turbine component of claim 1, further comprising a liner shell defining a panel-shell gap between the combustor wall and the liner shell.

9. The gas turbine component of claim 1, wherein the combustor wall comprises a top coat, a bond coat, and a base metal, wherein the air jet passes through the top coat, the bond coat, and the base metal.

10. The gas turbine component of claim 1, wherein an entire perimeter of the upstream side of the dilution hole is flush with the combustor wall.

11. The gas turbine component of claim 1, wherein the air jet is defined solely by the combustor panel.

12. The gas turbine component of claim 1, wherein a velocity of the air flow through the air jet inlet is less than a velocity of the air flow passing through the dilution hole.

13. The gas turbine component of claim 10, wherein the exit of the dilution hole is flush with an exit of the air jet.

14. A method of deflecting secondary flows produced within a combustor comprising:
positioning an air jet in close proximity to a dilution hole in a panel; and
expelling an air flow from the air jet to manipulate a pressure gradient in the vicinity of an exit of the dilution hole;
wherein the air flow from the air jet is configured to deflect secondary flows produced within the combustor;
the air jet is located in a proximity sufficient to a leading edge of the dilution hole such that the air flow from the air jet influences the pressure gradient in the vicinity of the exit of the dilution hole;
the air jet is located on an upstream side of the dilution hole; and
the air jet extends through a wall defining the dilution hole to provide an air jet inlet fed by an air flow passing through the dilution hole.

15. The method of claim 14, wherein a shape of an opening of the air jet mirrors a curvature of an opening of the dilution hole.

16. The method of claim 14, wherein the air flow from the air jet is configured to have less momentum than the flow of cooling fluid exiting the dilution hole.

17. The method of claim 14, wherein the air jet is located at the leading edge of the dilution hole.

18. The method of claim 14, wherein the air flow from the air jet is configured to reduce at least one of downwash flow or a recirculating flow and associated vortical structures from bringing hot temperatures within the combustor down to a liner surface of the combustor.

19. The method of claim 14, wherein a flow area of the air jet is substantially equal to or less than the flow area of the dilution hole.

20. The method of claim 14, wherein a velocity of an air flow through the air jet inlet is less than a velocity of the air flow passing through the dilution hole.
